(19) United States
(12) Patent Application Publication
(10) Pub. No.: US 2007/0102511 A1
(43) Pub. Date: May 10, 2007

(54) Method of providing secured access with payment device

(75) Inventor: Tony Jae Park, Edgewater, NJ (US)

Correspondence Address: COHEN, PONTANI, LIEBERMAN & PAVANE, 551 FIFTH AVENUE, SUITE 1210, NEW YORK, NY, 10176, US

(73) Assignee: Nextran Group

(21) Appl. No.: 11/352,479

(22) Filed: Feb. 9, 2006

Related U.S. Application Data
(60) Provisional application No. 60/736,142, filed on Nov. 10, 2005.

(51) Int. Cl. G06K 5/00

(52) U.S. Cl. 235/382

(57) ABSTRACT

A method of providing electronic reservation, authorization and access to a secured area or activity with the prior use of a payment device through a self-service kiosk, the internet, a telephone system, or a traditional goods and/or services counter staffed by an individual(s). The method will enable a customer to confirm, alter or make a reservation with a traditional payment device and thereafter utilize the same payment device to gain access to a secured area or activity. The method may be utilized for hotel reservations, sporting events, concerts, and other types of activities, which require authorization and payment for access to a secured place.

### RELATED APPLICATIONS

This application claims priority from U.S. Provisional Patent Application Ser. No. 60/736,142 which was filed on Nov. 10, 2005.

### BACKGROUND OF THE INVENTION

1. Field of the Invention

The present invention relates to a method of providing electronic reservations, authorization, and access to various secured places, including hotel rooms, through the prior use of self-service kiosks, the internet, telephones, or traditional goods and/or services counters, and more particularly, relates to a method for providing access to secured areas through the use of a payment device (used for the underlying transaction) at an entry point. The present invention can also be integrated for use with a traditional automatic teller machine (ATM) or other type of banking machine.

2. Description of the Related Art

The growth of the internet has allowed customers to benefit from online reservation systems and marketplaces. Placing orders on the internet for goods and/or services is becoming increasingly popular because individuals can conduct online research and make a purchase from the comfort of their own homes or offices. Of course, many individuals continue to use telephones to make a reservation or purchase. Others may opt for the more traditional and personable experience—using a goods and/or services counter staffed by an individual.

Self-service kiosks are becoming commonplace in places such as airports, hotels, and restaurants. Instead of having to wait in long lines for several minutes or even possibly hours to speak to a ticket agent, customer service representative, or hostess, individuals use self-service kiosks for many types of transactions. Such self-service kiosks are convenient, save the customer time, and inevitably allow the individual to pick and choose his or her preferences for the requested goods and/or services. Consumers also benefit from self-service kiosks because they are easy-to-use.

Kiosks, in particular, have the ability to simultaneously improve both customer processing and customer service. They allow companies to focus their attention on those customers who need human assistance. Self-service kiosks help reduce customer-handling costs and offer a near problem-free operation in an unattended environment with remote management capability.

One of the first types of self-service kiosks was the automatic teller machine or ATM. These kiosks are now all over the world and allow individuals to withdraw money at any hour of the day without having to go to a bank teller. ATMs are easily accessible, uncomplicated, and fast. The user only needs a payment card (debit, check, or credit card) and a personal identification number or PIN. Generally, upon inserting a payment card into a machine, entering a PIN, and selecting the amount of cash desired, the kiosk dispenses the requested amount of money (so long as the individual meets the terms of service with the bank and ATM provider).

In the aviation industry, airlines have significantly increased the number of check-in kiosks throughout airport terminals. Kiosks have become an integral part of the travel business because they simplify travel for passengers, airlines, and airports. The need for large airline check-in counters staffed with customer service agents is reduced.

In essence, fliers have the ability to utilize a payment device at a kiosk to electronically retrieve an existing airline reservation, change flights or connections, print boarding passes, upgrade to business-class or first-class, access frequent flier information, purchase a ticket, and the like. In addition, fliers can choose their seat on the airplane and at times, their meal preferences for the flight. These check-in kiosks then dispense a boarding pass, which is used to board the plane. The entire process can take as little as 30 seconds.

Similarly, hotels have begun incorporating self-service kiosks into their lobbies. Hotel guests no longer have to stand in a line to speak to a hotel desk clerk for purposes of checking-in and/or checking out. They instead benefit from a user-friendly touch-screen kiosk. These hotel kiosks maintain the advantages of those at airports and offer hotel guests an effortless alternative for checking into their rooms. Hotel kiosks can allow guests to change their reservation, pick their room, add new rooms, choose the number and type of beds, select a particular window view, upgrade rooms, pay for rooms, check-out, drop-off room keys or key cards, and the like.

The hotel guest uses a payment device to gain access to the electronic services of a kiosk, which can also be used as the form of payment for the room(s). Instead of printing a boarding pass, hotel kiosks generate a key or magnetic key card that is dispensed at the kiosk or retrieved from a separate area, such as a key counter, which may or may not be staffed by a person. The key or magnetic key card is configured to give the guest access to his or her hotel room(s) by inserting the key or magnetic key card into the room lock on the outside of the door.

Kiosks can also provide for other services. For example, they can generate maps of the area, print coupons, and find entertainment options, much like a personal concierge. In the film industry kiosks can provide movie times and dispense movie tickets. Undoubtedly, self-service kiosks are expanding to a large number of fields to benefit individuals who seek particular goods and services.

The self-service kiosks that have been described are in the prior art. Generally, the kiosks operate in a similar manner and serve the primary purpose of facilitating the purchase of goods and/or services. Yet, these kiosks suffer from many disadvantages. Primarily, users of current self-service kiosks still need to obtain an access object, such as a boarding pass, key-card, or ticket from the kiosk itself or a separate area. Having to remember to retrieve the access object, keep it in a safe place, and then learn to use it appropriately can be tedious, time consuming, and inconvenient. For example, it is not uncommon for individuals to lose their boarding passes or key cards on the way to their gate or hotel room. In addition, access objects are an added burden to customers for the simple reason that it is something extra to carry and manage.

Another fundamental problem associated with access objects is the design, development, production, and storage of the same. Access objects are wasteful as they are commonly for temporary use only. It is clearly a hassle for companies to maintain the functionality of the access objects, as they are prone to wear and tear, loss, and inoperability. In the case of paper boarding passes or tickets, they need to be disposed of by the airline after a single use. Traditional access objects, such as tickets, can also delay entry into a secured area as another individual must retrieve the access object from the user, verify its authenticity by sight or electronic means, and thereafter dispose of the access object.

Magnetic key cards at hotels have minimal shelf life and the preservation thereof can be costly. Additionally, magnetic key cards have created privacy and security concerns because hotels have the ability to encode personal information on the magnetic key cards. Hackers can extract this type of personal information. Therefore, hotel guests are forced to be cautious with magnetic key cards and dispose of the magnetic key cards appropriately, even cutting the magnetic key card into pieces to prevent identity theft.

Traditional kiosks also fail to combine the fundamental task of retrieving money from an ATM with that of conducting a transaction such as purchasing an airline ticket or making a hotel reservation. For example, an individual who may need to withdraw cash from a bank account and simultaneously check into his or her hotel room would need to use separate kiosks, 1) the ATM machine; and 2) the hotel self-service kiosk for check-in.

Accordingly, a method for providing access to secured places where the user can utilize his or her payment device for conducting a transaction and again as the access object to gain entry is needed. The underlying transaction, which requires the use of a payment device, can be conducted through a self-service kiosk, the internet, a telephone system, or even with a traditional goods and/or services counter that is staffed by an individual(s). The ability to conduct such a transaction at a kiosk, which also functions as an ATM or other type of cash machine, is also needed.

### SUMMARY OF THE INVENTION

The present invention is directed to a method for accessing secured places or events based on an underlying transaction at a self-service kiosk, on the internet, through a telephone, or in person at a goods and/or services counter that is staffed by an individual(s). The method allows for the use of a payment device(such as a debit, check, credit card or any other identifying device that can also render payment) for the underlying transaction and thereafter use of the same payment device to gain access to the corresponding secured places and/or events.

In accordance with one aspect of the present invention, a method of providing access to an individual who seeks services and/or access to a secured place or event, such as a hotel room or sporting event, includes identifying the transaction to a self-service kiosk, the internet, phone system, or an individual who is staffed at a goods and/or services counter, through the use of a payment device, accessing a previously made reservation or making a new reservation, choosing personal preferences, confirming the transaction, and making the payment device an access object for the particular service, secured place, or event such that the payment device is used to gain access to the particular service, secured place or event.

In accordance with yet another aspect of the present invention, the method also includes providing the user with access to an account wherein a traditional ATM-type or cash machine-type transaction can be made at a self-service kiosk in conjunction with or separate from the underlying transaction.

It is a further object the present invention to provide a method of completing a transaction at a self-service kiosk, on the internet, through a phone system, or at a goods and/or services counter that is staffed with an individual, which eliminates the need to obtain an access object for entry to a secured place or event.

It is an additional object of the present invention to dispense an access object at a kiosk or goods and/or services counter, if the individual requests this type of action, such as a key-card for a hotel room for another guest.

Yet another object of the present invention is to provide a method for using a payment device, at an entry point of a secured place, which has a corresponding payment device reader, to gain entry into the secured area based upon previous use of the payment device at a self-service kiosk, on the internet, through a phone system, or at a goods and/or services counter, for the underlying transaction.

It is still a further object of the present invention to provide a method of conducting a transaction at a self-service kiosk, on the internet, through a phone system, or at a goods and/or services counter, with a payment device, wherein a unique customer identifier is created that corresponds to the payment device and the underlying transaction, and is transmitted to a receiver, which is appropriately linked to an entry point, such as a lock on a hotel room door, for purposes of identifying the individual when the payment device is used to gain access to a secured area.

In accordance with another aspect of the present invention, the self-service kiosk, internet website, phone system, or goods and/or services counter is linked to a reservation system, such as a hotel or sporting event reservation system, with remote management capabilities.

Other features and advantages of the present invention will be understood upon reading and understanding the detailed description of the preferred exemplary embodiments, found herein below, in conjunction with reference to the drawings, in which like numerals represent like elements.

### BRIEF DESCRIPTION OF THE DRAWINGS

In the drawings:

FIG. 1 is a schematic illustrating the general configuration for the present invention.

### DETAILED DESCRIPTION OF THE PRESENTLY PREFERRED EMBODIMENTS

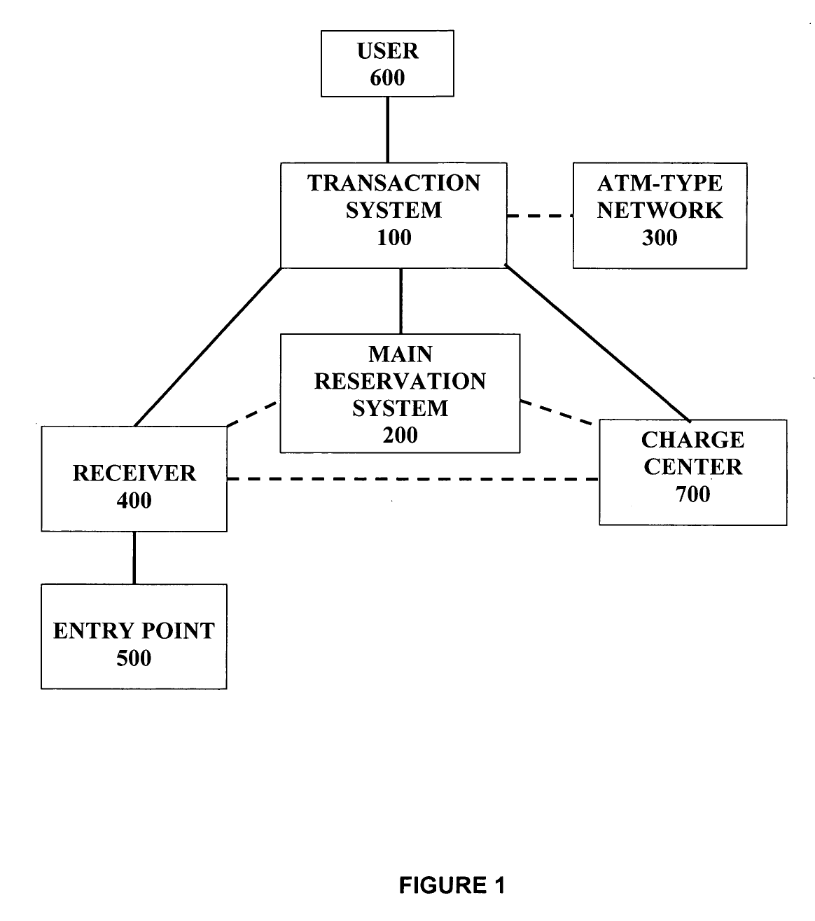

FIG. 1 generally depicts a method describing a system using the instant invention. A hotel reservation system is selected as an example. An individual who seeks to check-in, check-out, make changes to a reservation, or make a new reservation at a hotel initially uses a transaction system 100, such as a self-service kiosk, an internet web page, a phone system, or the hotel reservation counter (a goods and/or services counter staffed by an individual) for their desired course of action. The transaction system 100 is electronically linked through a network to a traditional main reservation system 200. The transaction system 100 is also networked to a receiver 400, which receives information from transaction system 100 or main reservation system 200 to uniquely identify user 600 and the payment device used for the transaction. Main reservation system 200 and receiver 400 may also be linked. Receiver 400 is linked to and can be part of entry point 500, which functions as a lock on a hotel room door. If transaction system 100 is a self-service kiosk, it can be integrated into an ATM or other type of cash machine and accordingly be connected to an ATM or point-of-sale (POS) network 300.

In a preferred embodiment, transaction system 100 is a self-service kiosk such that it generally corresponds to a standard computer kiosk station, which can handle requests for transactions such as hotel reservations. The kiosk can be designed in a variety of enclosures including those that are stand-alone, wall-mounted, desktop or countertop integrated, and mobile for transport purposes. In alternative embodiments, access transaction system 100 is the internet, a phone system, or a check-in counter at a hotel, as commonly used for hotel reservations.

Transaction system 100 is part of a larger reservation or ticketing network known as main reservation system 200. As an example for hotel services, the self-service kiosk is part of a hotel reservation network. Thus, the kiosk is capable of retrieving, storing, and manipulating hotel reservation information. The kiosk can also communicate with main reservation system 200 by wired or wireless means. Similarly, main reservation system 200 can communicate with the kiosk to keep information updated continuously. The function of the main reservation system 200 is to provide transaction system 100 with information generally relating to hotel room availability, pricing, and the like and vice-versa.

The self-service kiosk and/or the main reservation system 200 is also in communication with charge center 700 via a communication link in order to obtain clearance for payment devices used at the kiosk. The communication link may either route information from the kiosk directly to a charge center 700, or alternatively from the kiosk to the main reservation system 200 and then to charge center 700. Charge center 700 provides authorization, which may be required to accept a payment device introduced to one of the self-service kiosks.

The kiosk includes general features such as a screen for providing prompts and information to user 600, keys or a keypad or a plurality of keypads, and areas for receiving and reading payment devices. At a minimum, self-service kiosk must have the ability to communicate with user 600, either through the use of a screen, speaker, or printed paper, for example, and further the ability to receive information from the user 600 such as keypads, a microphone, or the like. In addition, the kiosk may include a receipt generator and receipt dispenser. Alternatively, the kiosk can be part of an ATM or similar cash machine and have the traditional benefits associated therewith including slots for dispensing cash and making deposits, allowing user 600 to make ATM-type transactions and also hotel transactions at one kiosk.

In a preferred embodiment which involves hotel reservations, user 600 conducts a transaction at the kiosk. The transaction may be initiated by introducing a payment device to the kiosk. For example, through the swipe of a credit card in the corresponding credit card reader on the kiosk. The transaction may also be initiated through other means, such as entering a reservation number, name, and the like. User 600 may then use the kiosk to make a hotel reservation or to access a previously made reservation and make modifications or render payment. The kiosk may also display a set of instructions for the user to follow, which may or may not require initial presentation of a payment device. In alternative embodiments, user 600 enters the relevant information onto a web page on the internet or provides the information over a phone system or to an individual at the hotel reservations counter. This can be for the purposes of accessing an existing hotel reservation or making a hotel reservation. For a kiosk-based transaction system, user 600 provides on-screen selection at the kiosk for the desired course of action, thereby initiating dialogue with the main reservation system 200.

For example, the kiosk may prompt the user for a reservation number or alternatively, automatically retrieve and display existing reservation information based solely on the presentation of the payment device. The kiosk may prompt the user to answer questions relating to preferences for a hotel room such as smoking or non-smoking, the number of beds, the type of view, floor preference, and the like. Similar inquiries may be presented if user 600 uses the internet, phone reservations, or simply approaches an individual at the hotel reservation desk. These preferences may or may not be taken into consideration to complete the underlying transaction.

Once the preferences have been selected for the transaction, payment information must be provided to complete the transaction. The user's payment device is applied to a payment device reader to provide this information. This may require a swiping of the payment device in an appropriate payment device reader, holding the payment device against or near a payment device reader, and the like. The payment information may be provided at any appropriate time during the transaction as prompted by the kiosk. If the payment device is used initially to begin a transaction, user 600 may or may not have to present the device again at the end of the transaction. The payment device is preferably used as the form of payment for the underlying transaction. In an alternative embodiment, user 600 may later choose to pay for the underlying transaction with a different payment device or even cash.

It is important to note that the payment device need only identify the user and have the capability of rendering payment. Therefore, the present invention encompasses not only traditional payment devices such as credit, debit, and check cards, but also payment devices which may mature in the future.

For an internet or phone system, payment information is provided through traditional means such as a keyboard, voice, or keypad. With respect to a hotel reservations counter, user 600 provides the payment information to the hotel employee who enters the information into the system or user 600 may be asked to enter the information him or herself through any of the aforementioned means.

Thereupon, a unique customer identifier is generated based on a number of criteria such as the payment device, the user's name, the hotel room assigned, and the like. The unique customer identifier is preferably generated by an algorithmic formula. A unique customer identifier is preferred over the use of merely the name of a hotel guest or the payment device number to enhance security. The unique customer identifier is used to identify the payment device employed with the underlying transaction and transaction system 100. In other words, the payment device and the transaction are associated with the generated unique customer identifier and the hotel room for the transaction.

The unique customer identifier is transmitted to receiver 400. Receiver 400 may be integrated into main reservation system 200, entry point 500, or can be separate from both. Entry point 500 is the point at which the payment device be presented to gain access to a secured place or event. For hotel reservations, entry point 500 is a traditional lock mechanism on a hotel room door with a payment device reader. Preferably, entry point 500 and receiver 400 are integrated into a single lock mechanism on a hotel room door. If entry point 500 and receiver 400 are not integrated into a single device, they are connected via a communications link.

User 600 is then able to use the payment device, which was used with transaction system 100, at entry point 500 for entry into a secured place or event. The payment device is applied to a payment device reader at entry point 500. A significant aspect of the present invention is the ability to determine if the payment device used at entry point 500 was previously used with transaction system 100 and matches the unique identifier to which it was assigned for the particular hotel room. Thus, the identifying characteristics of the payment device, e.g. the name, credit card number, or other information embedded on the magnetic strip of a credit card, are analyzed to determine if the payment device matches the corresponding unique customer identifier for that particular hotel room. The matching analysis may include assigning a matching value to the analysis such that a particular matching value unlocks the door.

The matching analysis can take place at entry point 500, receiver 400, or elsewhere. The place of matching analysis is insignificant for purposes of the present invention so long as entry point 500 grants or denies access to the hotel room based on such matching analysis. Entry point 500 must be linked to the point of matching analysis to receive the appropriate matching data. If the payment device used at entry point 500 registers as a match to the previously used payment device with transaction system 100 for the same underlying transaction to which a unique customer identifier was assigned for that hotel room, entry point 500 grants access to the hotel room by unlocking the door. If the analysis does not render a match, access to the hotel room is denied and the door remains locked. In other words, user 600 must first use the payment device with transaction system 100 and thereupon use the same payment device at entry point 500 to gain entry into the assigned hotel room.

Thus, the present invention allows for a payment device used for an underlying transaction to also function as an access object, which in the case of hotel reservations is a key card for a hotel room. A user may use a payment device, to check into a hotel and use the same payment device to enter the assigned hotel room.

In the event that user 600 wishes to have a traditional key card, either as a substitute for the payment device as a functioning key card or a copy for their pleasure, kiosk 100 has the ability to generate such a key card. In addition, kiosk 600 can be programmed to display or print additional hotel information such as maps of the hotel indicating, for example, the precise location of the reserved room, area restaurants, and local activities.

As discussed previously, transaction system 100 for a hotel reservations system may not only be a self-service kiosk, but can be a hotel web page on the internet, a phone-based hotel reservations system, or a traditional hotel check-in counter. In any one of these embodiments, the payment device used for the underlying transaction functions as an access object.

The overall method of the present invention can also be employed for sporting events, concerts, movies, conferences, and other secured places or events to eliminate the need for actual paper tickets. Much like a hotel reservation system, once an individual uses a self-service kiosk, the internet, a telephone system, or traditional goods and/or services ticket counter, a unique customer identifier is generated based on the payment device used. Entry point 500 is appropriately a gate, turnstile, or the like, with a payment device reader, which gives access to the secured event if the payment device matches the unique customer identifier for the underlying transaction.

For example, a user who purchases a ticket to a baseball game on the internet with a payment device need only present the same payment device at the entry point (with a corresponding payment device reader) of the stadium to gain access to the game. The user will not need to print a ticket at home or pick-up a ticket at the will-call window. The requirement for a ticket is eliminated and the payment device used for the underlying transaction functions as the access object.

The instant invention has been shown and described herein in what is considered specific exemplary embodiments. It is recognized, however, that departures may be made therefrom and that the present invention is intended to cover all modifications and equivalents within the scope of the appended claims.

I claim:

1. A method for accessing secured places or events comprising the following steps:
(a) conducting a transaction through the use of a transaction system and with a payment device;
(b) creating a unique customer identifier for said transaction;
(c) transmitting said unique customer identifier to a receiver;
(d) using said payment device as an access object at an entry point, which is in communication or integrated with said receiver;
(e) conducting a matching analysis of said payment device used at said entry point with said unique customer identifier; and
(f) allowing or denying access to said secured place or event based on said matching analysis.

2. A method for accessing secured places or events comprising the following steps: (a) identifying a previously made transaction to a transaction system;
(b) completing said transaction with the use of a payment device;
(c) creating a unique customer identifier for said transaction;
(d) transmitting said unique customer identifier to a receiver;
(e) using said payment device as an access object at an entry point, which is in communication or integrated with said receiver;
(f) conducting a matching analysis of said payment device used at said entry point with said unique customer identifier; and
(g) allowing or denying access to said secured place or event based on said matching analysis.

3. A method for accessing secured places or events according to claim 1 wherein said transaction system is kiosk-based.

4. A method for accessing secured places or events according to claim 1 wherein said transaction system is internet-based.

5. A method for accessing secured places or events according to claim 1 wherein said transaction system is telephone-based.

6. A method for accessing secured places or events according to claim 1 wherein said transaction system is human-based.

7. A method for accessing secured places or events according to claim 1 wherein said secured place or event is a hotel room.

8. A method for accessing secured places or events according to claim 1 wherein said secured place or event is a sporting event.

9. A method for accessing secured places or events according to claim 1 wherein said secured place or event is a concert.

10. A method for accessing secured places or events according to claim 1 wherein said secured place or event is a conference.

11. A method for accessing secured places or events according to claim 3 wherein said kiosk-based transaction system comprises a kiosk integrated with an automatic teller machine.

12. A method for accessing secured places or events according to claim 1 wherein said transaction comprises making a reservation.

13. A method for accessing secured places or events according to claim 12 wherein said transaction further comprises rendering payment with said payment device for said reservation.

14. A method for accessing secured places or events according to claim 2 wherein said previously made transaction is a reservation.

15. A method for accessing secured places or events according to claim 14 wherein completing said transaction comprises making modifications to said reservation.

16. A method for accessing secured places or events according to claim 15 wherein completing said transaction further comprises rendering payment with said payment device for said reservation.

17. A method for accessing secured places or events according to claim 2 wherein said transaction system is kiosk-based.

18. A method for accessing secured places or events according to claim 2 wherein said transaction system is internet-based.

19. A method for accessing secured places or events according to claim 2 wherein said transaction system is telephone-based.

20. A method for accessing secured places or events according to claim 2 wherein said transaction system is human-based.

21. A method for accessing secured places or events according to claim 2 wherein said secured place or event is a hotel room.

22. A method for accessing secured places or events according to claim 2 wherein said secured place or event is a sporting event.

23. A method for accessing secured places or events according to claim 2 wherein said secured place or event is a concert.

24. A method for accessing secured places or events according to claim 2 wherein said secured place or event is a conference.

25. A method for accessing secured places or events according to claim 17 wherein said kiosk-based transaction system comprises a kiosk integrated with an automatic teller machine.
